(19) United States
(12) Patent Application Publication
(10) Pub. No.: US 2004/0096308 A1
(43) Pub. Date: May 20, 2004

(54) Mechanical operating arm device having solid pawls

(76) Inventor: Hsun Lee, Chong Ho City (TW)

Correspondence Address: Hsun Lee, P.O. Box 10-69, Chong Ho, Taipei, 235, TW

(21) Appl. No.: 10/298,631

(22) Filed: Nov. 15, 2002

(51) Int. Cl. B66C 23/00

(52) U.S. Cl. 414/729

(57) ABSTRACT

A mechanical operating arm device includes an arm attached to a tractor, a seat rotatably secured to one end of the arm, a pair of pawls each having one end pivotally secured to the seat, and a pair of actuators coupled between the seat and the pawls respectively for actuating the actuators to operate the pawls. The tractor may include a control stick for moving the arm and the pawls to the required working position, and a foot pedal for operating the pawls to grasp objects. Two bars may be attached to the pawls and each has a number of projections for objects holding purposes.

### BACKGROUND OF THE INVENTION

1. Field of the Invention

The present invention relates to a mechanical operating arm device, and more particularly to a mechanical operating arm device for piling machine or excavating machine.

2. Description of the Prior Art

Typical mechanical operating arm devices have been developed for piling machines or excavating machines, and comprise a hydraulically operated manipulating arm attached to or supported by a motorized vehicle or tractor, for piling purposes, or for excavating purposes.

For the typical mechanical operating arm devices for the typical excavating machines, a pair of pawls are pivotally or rotatably secured to the end portion of the operating arm, and movable toward and away from each other by the hydraulic system.

However, the pawls are normally directly attached to the end portion of the operating arm, and operated or actuated by a single hydraulic cylinder, such that the pawls may not be used to solidly grasp the objects to be moved. In addition, the operators have to use one of their hands to hold and to grasp and to operate one of the control sticks, and the other hand to grasp and to operate the other control sticks.

The present invention has arisen to mitigate and/or obviate the afore-described disadvantages of the conventional mechanical operating arms.

### SUMMARY OF THE INVENTION

The primary objective of the present invention is to provide a mechanical operating arm device including a pair of solidly attached pawls for solidly grasping objects or for excavating purposes.

In accordance with one aspect of the invention, there is provided a mechanical operating arm device comprising an arm attached to a tractor, and including a first end, a seat rotatably secured to the first end of the arm, a pair of pawls each including a first end pivotally secured to the seat, and each including a second end, a pair of actuators coupled between the seat and the pawls respectively, and means for actuating the actuators to operate the pawls. It is preferable that a control stick is disposed or provided in the tractor for moving the arm and the pawls to the required working position, and a foot or control pedal is further provided and disposed in the tractor for moving the pawls toward each other or away from each other, for grasping objects or for releasing the objects.

The actuating means includes a valve coupled to such as the pressurized air reservoir or the hydraulic oil reservoir, a pair of tubes and a pair of hoses coupled to the actuators respectively for operating the actuators, or for supplying pressurized air or hydraulic oil into and out of the actuators.

The pawls each includes a bar selectively attached to the second end thereof. The bars each preferably includes a plurality of projections extended therefrom.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a mechanical operating arm device in accordance with the present invention;

FIG. 2 is a perspective view illustrating the operation of the mechanical operating arm device;

FIG. 3 is an enlarged partial bottom perspective view illustrating the hydraulic pipes of the mechanical operating arm device;

FIG. 4 is a further perspective view illustrating the operation of the mechanical operating arm device;

FIG. 5 is an enlarged partial perspective view illustrating the operation of the mechanical operating arm device; and

FIGS. 6, 7 are further perspective views illustrating the operation of the mechanical operating arm device.

### DETAILED DESCRIPTION OF THE PREFERRED EMBODIMENT

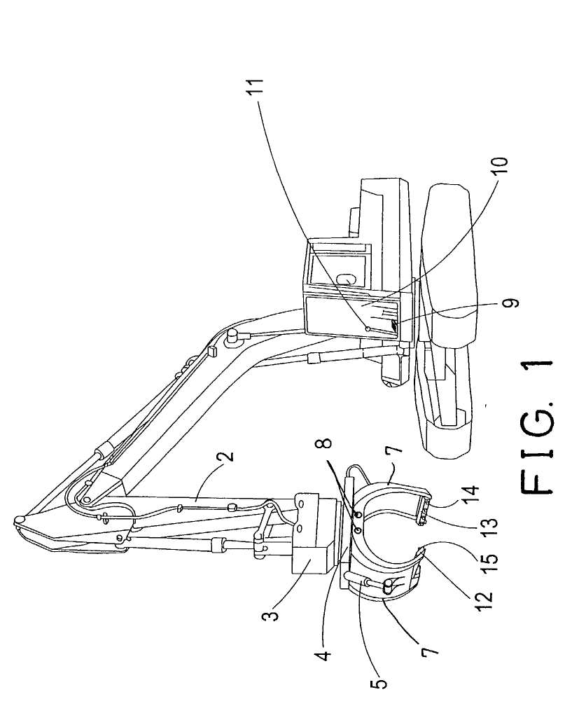

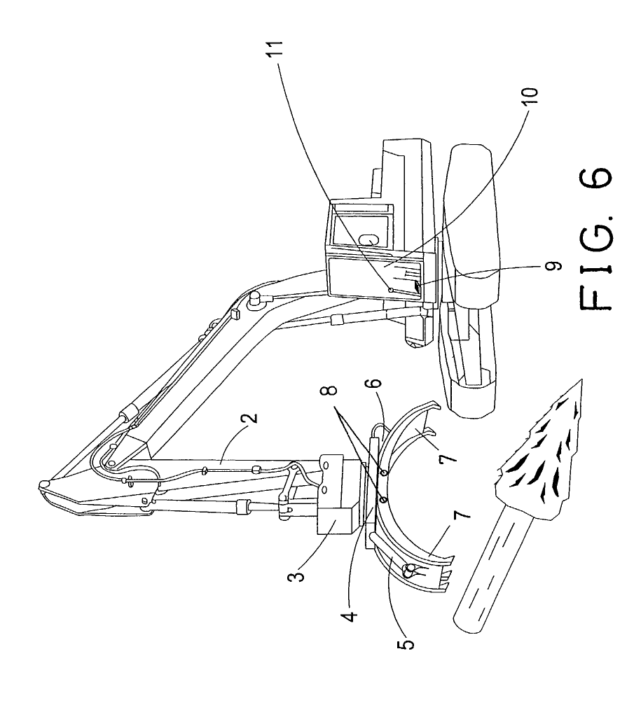

Referring to the drawings, and initially to FIGS. 1-5, a mechanical operating arm device in accordance with the present invention comprises a pneumatically or hydraulically operated manipulating arm 2 attached to or supported by a motorized vehicle or tractor 10, for such as piling purposes, or for excavating purposes.

A seat 4 is rotatably attached to one end, such as the free end 3 of the arm 2. Two pawls 7 each has one end pivotally or rotatably secured to the seat 4 with a pivot shaft 8 respectively, and two actuators 5, 6, such as the pneumatic or hydraulic cylinder 5, 6 coupled between the seat 4 and the pawls 7 respectively, for operating the pawls 7 respectively.

It is preferable that a control stick 11 is disposed or provided in the tractor 10, for operating or for moving the arm 2 and the seat 4 and the pawls 7 to the required position, and a foot or control pedal 9 is disposed or provided in the tractor 10, for operating the pawls 7 to grasp objects or for excavating purposes.

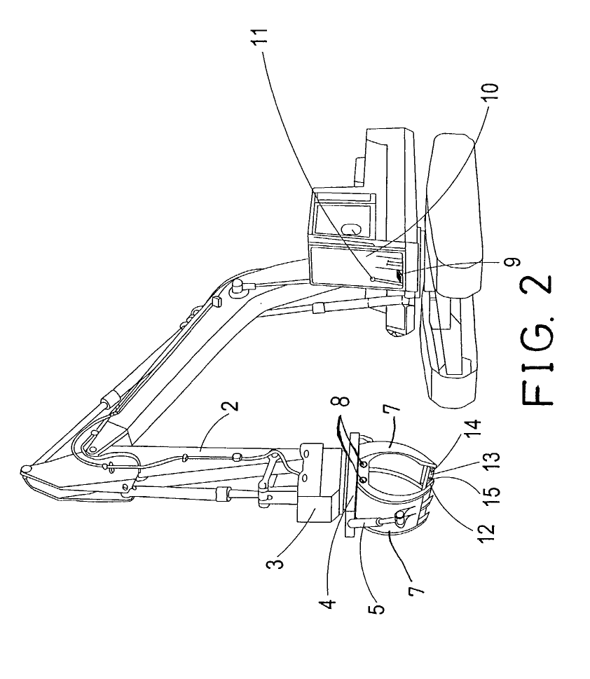

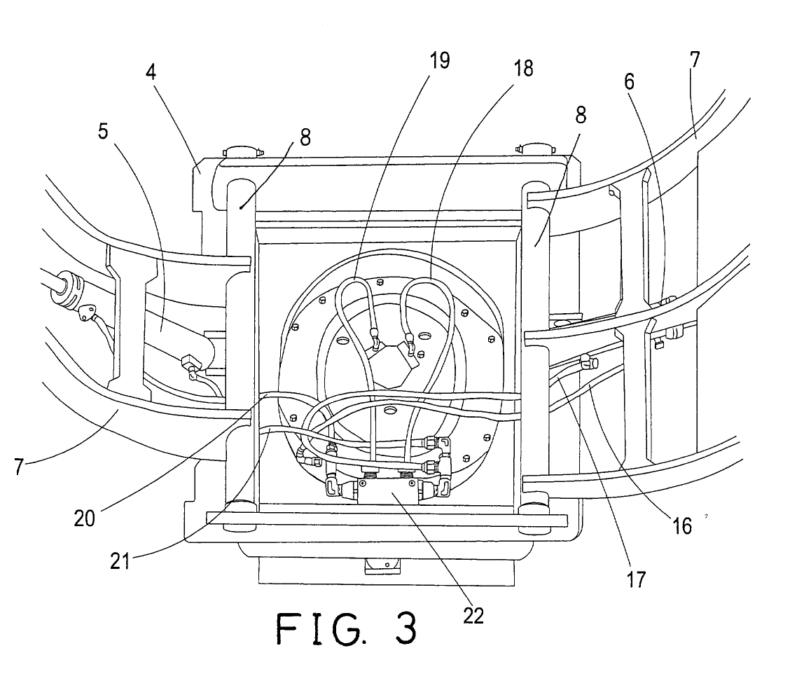

As shown in FIG. 3, a control valve 22 or the like is attached to the seat 4, and coupled to the pneumatic system or the hydraulic system with tubes 18, 19, for receiving pressurized air or hydraulic oil therefrom. Two tubes 17, 21 are coupled between the control valve 22 and the actuators 5, 6 respectively, for supplying the pressurized air or hydraulic oil into the actuators 5, 6, and for forcing the pawls 7 toward each other for object grasping purposes (FIGS. 2, 4, 5, 7).

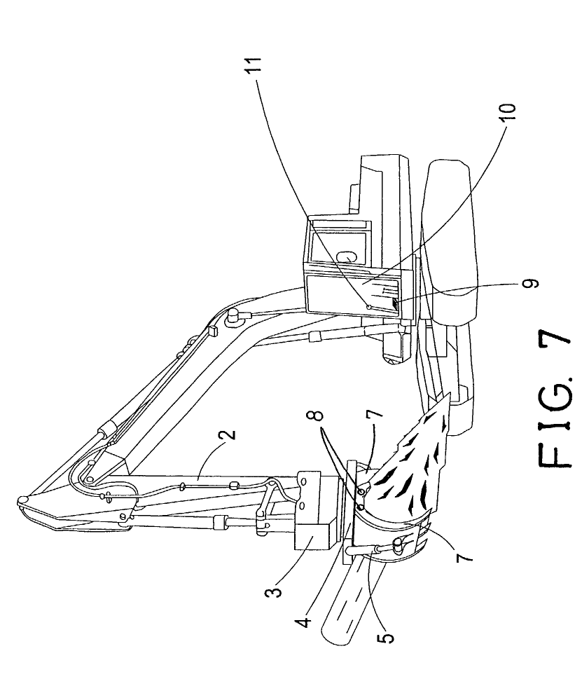

Two hoses 16, 20 are further provided and coupled between the control valve 22 and the actuators 5, 6 respectively, for removing the pressurized air or hydraulic oil out of the actuators 5, 6, and for moving or forcing the pawls 7 away from each other (FIGS. 1, 6).

The pawls 7 each includes a bar 12, 13 secured to the other end or the free end thereof, and the bars 12, 13 each preferably includes one or more projections 14, 15 extended therefrom, for allowing the smaller objects to be solidly grasped between the bars 12, 13 (FIGS. 2, 4, 5) and to be solidly held between the pawls 7.

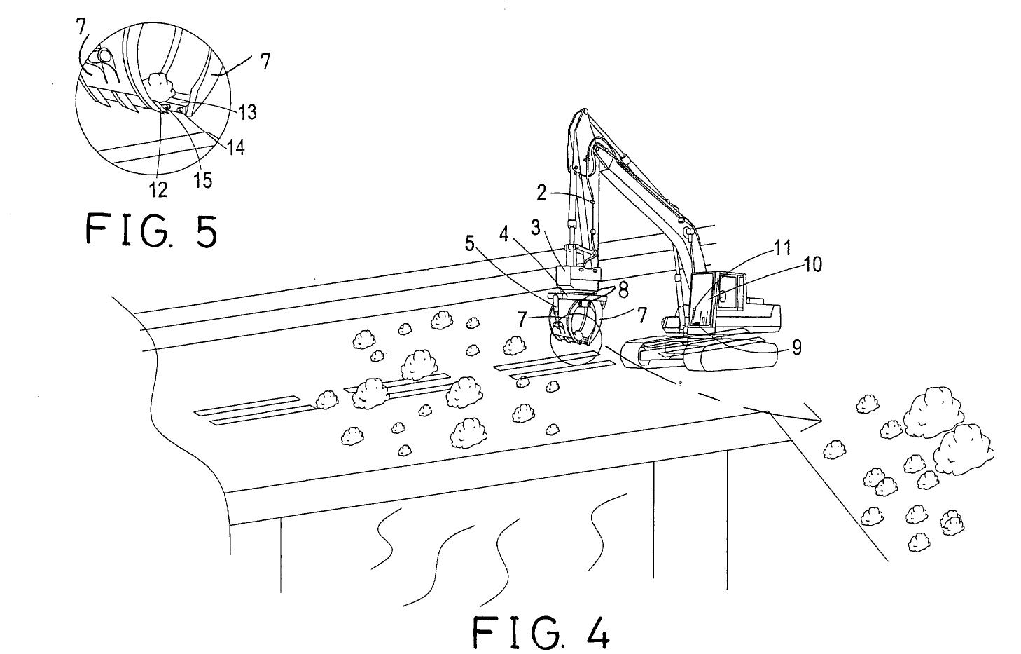

In operation, as shown in FIG. 4, the pawls 7 and the arm 2 may be moved or operated by the control stick 11 toward the required working position, and the pawls 7 may be operated or actuated by the actuators 5, 6 with the foot or control pedals 9, in order to grasp objects (FIGS. 4-7), or for excavating purposes. The pawls 7 may thus be solidly attached to the seat 4, and may be effectively operated by the actuators 5, 6 with the control pedal 9.

The bars 12, 13 may be optionally or selectively secured or attached to the pawls 7, for allowing the pawls 7 to grasp smaller objects.

Accordingly, the mechanical operating arm device in accordance with the present invention includes a pair of solidly attached pawls for solidly grasping objects or for excavating purposes.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A mechanical operating arm device comprising:
an arm attached to a tractor, and including a first end,
a seat rotatably secured to said first end of said arm,
a pair of pawls each including a first end pivotally secured to said seat, and each including a second end,
a pair of actuators coupled between said seat and said pawls respectively, and
means for actuating said actuators to operate said pawls.

2. The mechanical operating arm device according to claim 1, wherein said actuating means includes a valve, a pair of tubes and a pair of hoses coupled to said actuators respectively for operating said actuators.

3. The mechanical operating arm device according to claim 1, wherein said pawls each includes a bar selectively attached to said second end thereof.

4. The mechanical operating arm device according to claim 3, wherein said bars each includes a plurality of projections extended therefrom.
